(19) United States
(12) Patent Application Publication
(10) Pub. No.: US 2018/0155202 A1
(43) Pub. Date: Jun. 7, 2018

(54) METHODS FOR CARBON DIOXIDE PRODUCTION AND POWER GENERATION

(71) Applicants: Alexander Alekseev, Wolfratshausen (DE); Stevan Jovanovic, North Plainfield, NJ (US); Ramachandran Krishnamurthy, Bridgewater, NJ (US)

(72) Inventors: Alexander Alekseev, Wolfratshausen (DE); Stevan Jovanovic, North Plainfield, NJ (US); Ramachandran Krishnamurthy, Bridgewater, NJ (US)

(21) Appl. No.: 15/819,013

(22) Filed: Nov. 21, 2017

Related U.S. Application Data
(60) Provisional application No. 62/427,294, filed on Nov. 29, 2016.

(51) Int. Cl. C01B 32/50; B01D 53/60; B01D 53/34; B01D 53/26; H02K 7/18

(52) U.S. Cl. CPC C01B 32/50; B01D 53/60; F01K 13/00; B01D 53/265; H02K 7/1823; B01D 53/343

(57) ABSTRACT

A method of integrating energy into a power cycle during production of carbon dioxide using the steps of a) combusting a fuel and oxygen in a reactor to produce a mixture of carbon dioxide and water, and form a heat of reaction; b) capturing the heat of reaction; c) converting the heat of reaction into electrical energy; d) feeding the electrical energy into the power cycle; and e) purifying and recovering carbon dioxide. Alternatively, a method for the production of carbon dioxide and power is disclosed by a) combusting a fuel and oxygen in a reactor to produce a flue gas comprising carbon dioxide and contaminants and a heat of reaction; b) recovering heat from the reactor and producing electricity from the heat; c) integrating the electricity into a power cycle; and d) removing contaminants from the carbon dioxide and recovering purified carbon dioxide.

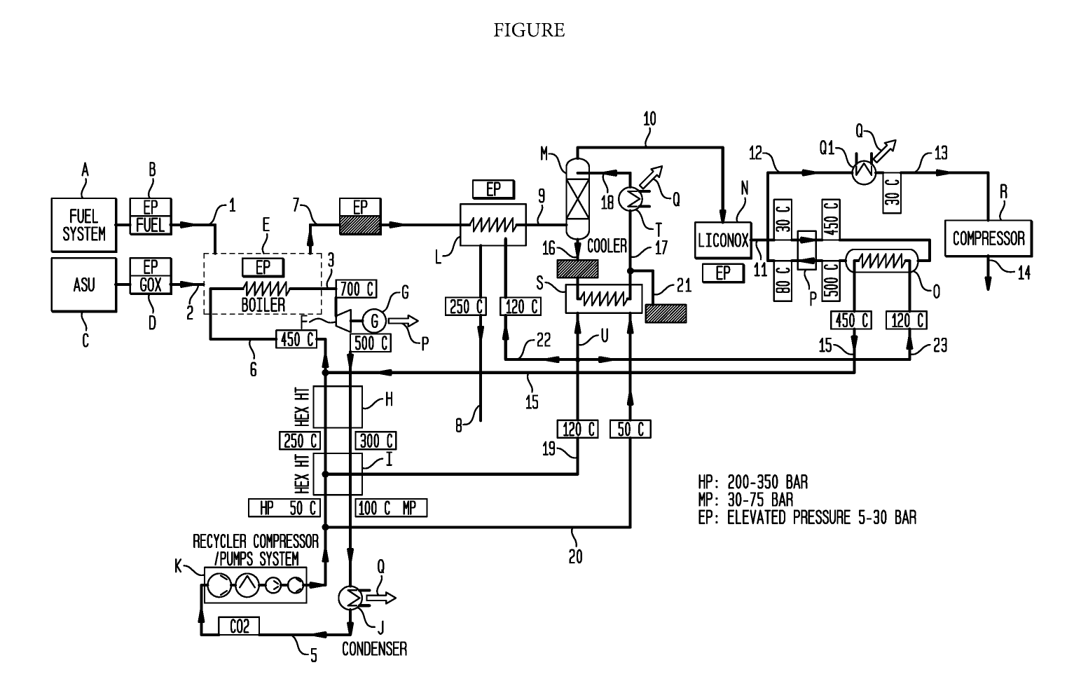

### CROSS REFERENCE TO RELATED APPLICATIONS

This application claims priority from U.S. Provisional Application 62/427,294 filed on Nov. 29, 2016.

### STATEMENT REGARDING FEDERALLY SPONSORED RESEARCH OR DEVELOPMENT

This invention was made with government support under Contract DE-FE0009448 awarded by the US Department of Energy. The government has certain rights in the invention.

### BACKGROUND OF THE INVENTION

The present invention relates to the simultaneous production of clean electric power and pure carbon dioxide. Typical carbon dioxide specifications for product purity will require the removal of water, other air species such as oxygen, nitrogen and argon and impurities such as sulfur oxides, nitrogen oxides, carbon monoxide and the like.

The removal of air gases, particularly oxygen can be challenging since for typical carbon dioxide operations such as enhanced oil recovery, the maximum content of oxygen has to be lower than 100 ppm sometime lower than 10 ppm. A typical oxygen slip from oxy-fuel combustion is in the range of 1 vol % to 5 vol % in a raw carbon dioxide effluent from a boiler. Such excess oxygen is a consequence of fuel combustion being performed under super-stoichiometric conditions where more oxygen is required for the stoichiometric combustion of fuel. A reduction of the excess oxygen is usually not possible because it leads to high carbon monoxide concentration; the carbon reacting partially to carbon dioxide and partially to carbon monoxide due to the less than ideal combustion ratios.

The conventional oxygen removal technology is based on cryogenic methods; raw carbon dioxide is first dried and cooled in one or more steps to temperatures slightly above −55° C. (the triple point of carbon dioxide). At this temperature, almost the entirety of carbon dioxide becomes liquid, the oxygen is still gaseous and can be readily separated by means of a simple separator or column.

Another option for oxygen removal is based on a catalytic deoxidation. A small amount of supplemental fuel such as hydrogen or a hydrocarbon is injected into the oxygen containing carbon dioxide gas. Preheated gas mixtures are then fed to a catalytic reactor where the supplemental fuel effectively reacts off contained oxygen while producing additional carbon dioxide and water.

The cryogenic oxygen removal systems can be relatively costly and ineffective since to remove 1 to 5% of oxygen, the entire amount of gas in the system must be cooled and condensed.

A typical non cryogenic, catalytic deoxidation approach also requires one of two expensive options. A significant recirculation of the reactor effluent back to the feed mixture, in order to reduce apparent oxygen content below 1% to be able to prevent overheating of needed noble catalyst bed. The resulting capital and operating cost for the recirculation blower/compressor along with the resulting multiple times bigger catalytic reactor caused by the required maximum gas space velocity for complete reaction make this option marginally more attractive than the cryogenic method.

Alternatively, a multistage catalytic reactor system, with multiple inter stage coolers will add significant capital cost to the system, while still limiting the efficiency of using the heat of reaction.

### SUMMARY OF THE INVENTION

In a first embodiment of the invention, there is disclosed a method of integrating energy into a power cycle during production of carbon dioxide comprising the steps;

a) Combusting a fuel and oxygen in a reactor to produce a mixture of carbon dioxide and water, and form a heat of reaction;
b) Capturing the heat of reaction;
c) Converting the heat of reaction into electrical energy;
d) Feeding the electrical energy into the power cycle; and
e) Purifying and recovering carbon dioxide.

The power cycle that is employed in processing the flue gas stream is typically that electricity that is needed for separation and purification devices.

The fuel is typically hydrogen or a natural gas such as pipeline natural gas, compressed natural gas or liquefied natural gas. The oxygen is gaseous oxygen that can be derived from air separation units such as large or small cryogenic separation devices.

The reactor is typically a boiler whereby a chemical reaction causes steam to form in pipes integrated therein. The heat of reaction from the chemical reaction is withdrawn as thermal energy to a compressor and fed to an expander where it can be captured as electrical power. This electrical power can then be used in powering several of the separation and purification systems that are treating the flue gas stream.

The boiler is integrated with the downstream processing of the flue gas in that various heat exchanger and recovery options capture heat from the flue gas stream being treated and return this heat to the heat exchangers in fluid communication with the boiler. The boiler is further integrated with the compressor and expander as some of the steam is drawn off at 500° C. from the compressor and fed through at least two heat exchangers before the steam is fed to a recycle compressor system consisting of one or more pumps which will increase the pressure of the steam and feed the stream through the at least two heat exchangers before entering the boiler at 450° C.

The flue gas that results from the combustion of the fuel and the oxygen is recovered from the reactor and is fed at pressure of 5 to 30 bars to a cooling section whereby water is separated from the flue gas stream. The cooling section further comprises a direct contact cooler where hot condensate is separated from the rest of the flue gas stream which is fed to a device for removing contaminants such as nitrogen oxides and sulfur oxides from the flue gas stream.

The hot condensate is fed through a heat exchanger which is in fluid communication with the heat exchanger system providing steam to the reactor/boiler. This heat exchanger is also in fluid communication with a downstream heat exchanger which will use the heat from the hot condensate heat exchanger and provide it to an oxygen separation system.

The flue gas once it has been treated for nitrogen oxides and sulfur oxides is fed to a process whereby oxygen and inert gases that may still be present in the flue gas stream are removed. The ensuing heat energy produced by this process can be captured. The flue gas stream that is now mostly purified carbon dioxide is fed to a compressor and recovered as purified carbon dioxide.

In a second embodiment of the invention, there is disclosed a method for the production of carbon dioxide and power comprising the steps of:

a) Combusting a fuel and oxygen in a reactor to produce a flue gas comprising carbon dioxide and contaminants, and a heat of reaction;
b) Recovering the heat of reaction from the reactor and producing electricity therefrom;
c) Integrating the electricity into a power cycle that is used to process flue gas; and
d) Removing contaminants from the carbon dioxide and recovering purified carbon dioxide.

In the method of the present invention, the fuel and oxygen are used super-stoichiometrically such that the fuel, be it hydrogen or pipeline natural gas, compressed natural gas or liquefied natural gas is used to react off excess oxygen in the isothermal catalytic reactor or boiler. This will result in full oxidation of the fuel to form carbon dioxide and water which will be captured from the reactor as the flue gas. This super-stoichiometric reaction will result in a heat of reaction which is recovered at a temperature near maximum reaction temperature. This recovered heat of reaction can be captured and utilized in the power cycle that is used to purify the carbon dioxide in the flue gas.

Alternatively, a sub-stoichiometric reaction can be performed which results in the need for extra oxygen to react with any excess carbon monoxide in the reactor or boiler. This will promote full oxidation of the carbon monoxide to carbon dioxide and will also form a heat of reaction which if recovered again at near its maximum temperature, can be integrated into the power cycle that is employed in purifying the carbon dioxide in the flue gas.

Consequently, the method of the present invention is to produce a carbon dioxide containing flue gas from the oxyfuel combustion of a hydrocarbon and oxygen while capturing the heat of reaction and integrating that heat of reaction into the energy that is used to process the carbon dioxide in the flue gas. By capturing the thermal energy of the heat of reaction, less energy needs to be generated for the power cycle for processing the flue gas stream.

### BRIEF DESCRIPTION OF THE DRAWINGS

The FIGURE is a schematic of a process for the production of power and clean carbon dioxide.

### DETAILED DESCRIPTION OF THE INVENTION

The FIGURE is a schematic of a process for the production of power while simultaneously producing carbon dioxide.

A fuel system A delivers fuel B at an elevated pressure of 5 to 30 bar through line 1 to a boiler E. An air separation unit C provides gaseous oxygen D through line 2 to the boiler E also at an elevated pressure of 5 to 30 bar. The boiler E is at an elevated pressure of 5 to 30 bar and heats the water to form steam in line 6 to temperatures up to 700° C. before being passed through line 3 to a compressor F and to an expander G where power is produced P.

The boiler E can typically contain an isothermal catalytic reactor which will operate to promote the full oxidation of the fuel and oxygen to produce water and carbon dioxide with minor amounts of impurities.

The temperature of the steam leaving the compressor F is 500° C. as fed through line 4 and this steam passes through a first heat exchanger H where there is a reduction in temperature to 300° C. before being passed to a second heat exchanger I where the steam exiting this heat exchanger I is at a temperature of 100° C. Line 4 delivers this lower temperature steam to a condenser J where heat may further be recovered as Q.

Line 5 exits the condenser J and feeds the steam/water mixture to a recycle compressor system consisting of a series of pumps K. The higher pressure steam/water mixture is fed through line 5 at a pressure of 200 to 350 bar and a temperature of 50° C. before entering the second heat exchanger I where it will gain heat and be at a temperature of 250° C. before entering the first heat exchanger H. The resulting higher temperature steam is fed through line 6 at a temperature of 450° C. into the boiler E where it will again generate the steam to cycle through the expander G and condenser J cycle.

Meanwhile, flue gas containing primarily carbon dioxide from the boiler E combustion is fed through line 7 to a heat exchanger L at a pressure of 5 to 30 bar. The heat exchanger L also operates at a pressure of 5 to 30 bar. Line 8 removes heat at a temperature of 250° C. for dissipation and the flue gas which is now lower in temperature is fed through line 9 into a dried contact cooler M. Hot water condensate leaves the bottom of the dried contact cooler M through line 16 and is fed to a heat exchanger S. The hot condensate leaves the heat exchanger S through line 17 where more condensate is separated off through line 21. The now cooler hot condensate enters a cooler T where heat Q is recovered. The now cooler hot condensate leaves the cooler T through line 18 where it will enter the direct contact cooler M to provide cooler water.

Heat exchanger S is also in fluid communication with line 20 which draws compressed steam from line 6 and recycle compressor system K through line 20 and feeds this cooler steam at a temperature of 50° C. to the heat exchanger S.

The heat exchanger S is also in fluid communication with line 19 which draws hot steam at a temperature of 120° C. to a three way valve U. Part of the steam may be fed through line 22 to the heat exchanger L thereby providing cooler steam to be heated in the heat exchanger L. Alternatively, the three way valve U feeds this steam through line 23 into heat exchanger O, discussed in detail below.

The third option is to feed the steam through three-way valve U and line 19 to heat exchanger I where it will contact line 6 and deliver heat in the form of steam to heat the steam being fed into heat exchanger H for reentry into boiler E.

The direct contact cooler feeds the cooler flue gas through its top through line 10 to a device N for removing sulfur oxides and nitrogen oxides from the flue gas. The device N may be a LICONOX reactor which typically operates at pressure of 5 to 30 bar. The flue gas stream now free of sulfur oxides and nitrogen oxides is fed through line 11 to a heat exchanger operation P where the flue gas stream enters the heat exchanger P at 30° C. and exits at 450° C. This hot flue gas stream is fed to another heat exchanger O which as discussed above receives steam through the three-way valve U at a temperature of 120° C. through line 23. The recovered heat from heat exchanger O is fed through line 15 at a temperature of 450° C. to line 6 where it will provide heat along with the steam from heat exchangers H and I to the boiler E.

The hot flue gas leaves the heat exchanger O at a temperature of 500° C. through line 12 and is fed back through heat exchanger P where its temperature is reduced to 80° C. This lower temperature flue gas stream is fed to heat exchanger Q1 where heat energy Q is also recovered from the process. The flue gas stream which is now at a much lower temperature of 30° C. is fed from Q1 and line 13 to a compressor R which compresses the flue gas stream and recovers carbon dioxide through line 14.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what we claim is:

1. A method of integrating energy into a power cycle during production of carbon dioxide comprising the steps;
a) Combusting a fuel and oxygen in a reactor to produce a mixture of carbon dioxide and water, and form a heat of reaction;
b) Capturing the heat of reaction;
c) Converting the heat of reaction into electrical energy;
d) Feeding the electrical energy into the power cycle; and
e) Purifying and recovering carbon dioxide.

2. The method as claimed in claim 1 wherein the power cycle is electricity that is used in separating and purifying the mixture of carbon dioxide and water.

3. The method as claimed in claim 1 wherein the fuel is selected from the group consisting of hydrogen and a natural gas selected from natural gas, compressed natural gas and liquefied natural gas.

4. The method as claimed in claim 1 wherein the oxygen is from an air separation device.

5. The method as claimed in claim 1 wherein the heat of reaction is from a super stoichiometric reaction or sub stoichiometric reaction.

6. The method as claimed in claim 1 wherein the heat of reaction is converted into electrical energy by feeding to a compressor and expander.

7. The method as claimed in claim 1 wherein the electrical energy is used to power downstream separation and purification systems.

8. The method as claimed in claim 1 wherein the reactor is a boiler.

9. The method as claimed in claim 8 wherein the boiler is in fluid communication with one or more heat exchangers thereby providing steam to the boiler.

10. The method as claimed in claim 1 wherein the mixture of carbon dioxide and water is fed to a water separation system.

11. The method as claimed in claim 1 wherein the carbon dioxide from the water separation system is fed to a system for removing nitrogen oxides and sulfur oxides.

12. The method as claimed in claim 11 wherein the carbon dioxide is fed to a device for removing oxygen and inert compounds.

13. The method as claimed in claim 1 wherein the purified carbon dioxide is fed to a compressor and recovered.

14. The method as claimed in claim 1 wherein a heat exchanger is in fluid communication with the water separation system.

15. The method as claimed in 14 wherein the heat exchanger in fluid communication with the water separation system is in fluid communication with the one or more heat exchangers providing steam to the boiler.

16. The method as claimed in claim 1 wherein a heat exchanger is in fluid communication with the device to remove oxygen and inert compounds.

17. The method as claimed in claim 16 wherein the heat exchanger in fluid communication with the device to remove oxygen and inert compounds is in fluid communication with the boiler.

18. A method for the production of carbon dioxide and power comprising the steps of:
a) Combusting a fuel and oxygen in a reactor to produce a flue gas comprising carbon dioxide and contaminants, and a heat of reaction;
b) Recovering the heat of reaction from the reactor and producing electricity therefrom;
c) Integrating the electricity into a power cycle that is used to process the flue gas; and
d) Removing contaminants from the carbon dioxide and recovering purified carbon dioxide.

19. The method as claimed in claim 18 wherein the power cycle is electricity that is used in separating and purifying the mixture of carbon dioxide and water.

20. The method as claimed in claim 18 wherein the fuel is selected from the group consisting of hydrogen and a natural gas selected from pipeline natural gas, compressed natural gas and liquefied natural gas.

21. The method as claimed in claim 18 wherein the oxygen is from an air separation device.

22. The method as claimed in claim 18 wherein the heat of reaction is from a super stoichiometric reaction or sub stoichiometric reaction.

23. The method as claimed in claim 18 wherein the heat of reaction is converted into electrical energy by feeding to a compressor and expander.

24. The method as claimed in claim 18 wherein the electrical energy is used to power downstream separation and purification systems.

25. The method as claimed in claim 18 wherein the reactor is a boiler.

26. The method as claimed in claim 25 wherein the boiler is in fluid communication with one or more heat exchangers thereby providing steam to the boiler.

27. The method as claimed in claim 18 wherein the mixture of carbon dioxide and water is fed to a water separation system.

28. The method as claimed in claim 18 wherein the carbon dioxide from the water separation system is fed to a system for removing nitrogen oxides and sulfur oxides.

29. The method as claimed in claim 28 wherein the carbon dioxide is fed to a device for removing oxygen and inert compounds.

30. The method as claimed in claim 18 wherein the purified carbon dioxide is fed to a compressor and recovered.

31. The method as claimed in claim 18 wherein a heat exchanger is in fluid communication with the water separation system.

32. The method as claimed in 31 wherein the heat exchanger in fluid communication with the water separation system is in fluid communication with the one or more heat exchangers providing steam to the boiler.

33. The method as claimed in claim 18 wherein a heat exchanger is in fluid communication with the device to remove oxygen and inert compounds.

34. The method as claimed in claim 33 wherein the heat exchanger in fluid communication with the device to remove oxygen and inert compounds is in fluid communication with the boiler.
